(19) United States
(12) Patent Application Publication
(10) Pub. No.: US 2008/0316316 A1
(43) Pub. Date: Dec. 25, 2008

(54) Digital camera capable of transmitting image data remotely

(76) Inventor: Yi-Chia Liao, Miaoli County (TW)

Correspondence Address: Joe McKinney Muncy, PO Box 1364, Fairfax, VA, 22038-1364, US

(21) Appl. No.: 11/812,488

(22) Filed: Jun. 19, 2007

(51) Int. Cl. H04N 7/18; H04N 5/225

(52) U.S. Cl. 348/155; 348/164; 348/220.1; 348/E07.085; 348/E07.086; 348/E05.03

(57) ABSTRACT

A digital camera aims to transmit image data captured by a camera lens to an external electronic device such as a PDA, 3G handset or personal computer. Hence the digital camera does not need a large capacity storage device to store the image data. The cost is lower. And users can instantly get images captured by the digital camera at a remote site. The risk of image data sabotage or tampering can be prevented to enhance burglar alarm effect to better meet users' requirement.

### FIELD OF THE INVENTION

The present invention relates to a digital camera used on surveillance and burglar alarm devices and particularly to a digital camera capable of transmitting image data instantly to a remote location.

### BACKGROUND OF THE INVENTION

A surveillance or video device can thwart crimes and burglars and provide onsite images where criminal actions take place. Thus it has become one of commonly used security equipment in communities, companies and residences.

Professional surveillance or video equipment are expensive, hence are not widely used on residences. To address this issue, R.O.C. patent publication No. M260065, entitled “Digital camera, capable of providing burglar alarm and surveillance function” and No. 586728, entitled “Digital camera capable of providing surveillance and burglar alarm function” disclose a digital camera to meet this purpose. It has a burglar alarm sensor located at a front side of the digital camera to activate the digital camera to start image capturing operation when detects movement of human body. It can take pictures one by one or video images continuously. Aside from serving as an ordinary digital camera, it also can provide burglar alarm function for residences. Hence it has more added value.

Although the conventional digital camera can provide burglar alarm function, its storage capacity to hold the image data is limited, and cannot provide desired burglar alarm function for a prolonged period of time. Moreover, while the host of the conventional digital camera to store the image data can be hidden, it is not difficult for experienced burglars to discover where it is located. As a result, the burglar alarm effect is not desirable.

### SUMMARY OF THE INVENTION

Therefore the primary object of the present invention is to provide a digital camera that can transmit image data remotely to solve the aforesaid disadvantages. The digital camera of the invention can capture image data and send the image data to an external electronic device at a remote site for storing.

To achieve the foregoing object the invention includes a camera host, a camera lens, a burglar alarm detection means and a control circuit. The control circuit includes a microprocessor, a cache memory and a transmission device. The microprocessor aims to send, receive and process signals of the camera host, camera lens, cache memory, burglar alarm detection means and transmission device. The camera lens is located on the camera host. When the burglar alarm detection means detects movement of human body the microprocessor issues a signal to the camera lens to proceed picturing taking process to get image data. The image data are stored temporarily in the cache memory, then are transmitted through the transmission device to the external electronic device in a wireless fashion.

The foregoing, as well as additional objects, features and advantages of the invention will be more readily apparent from the following detailed description, which proceeds with reference to the accompanying drawings.

### BRIEF DESCRIPTION. OF THE DRAWINGS

FIG. 1 is a block diagram of the elements of the invention in a linked condition.

### DETAILED DESCRIPTION OF THE PREFERRED EMBODIMENT

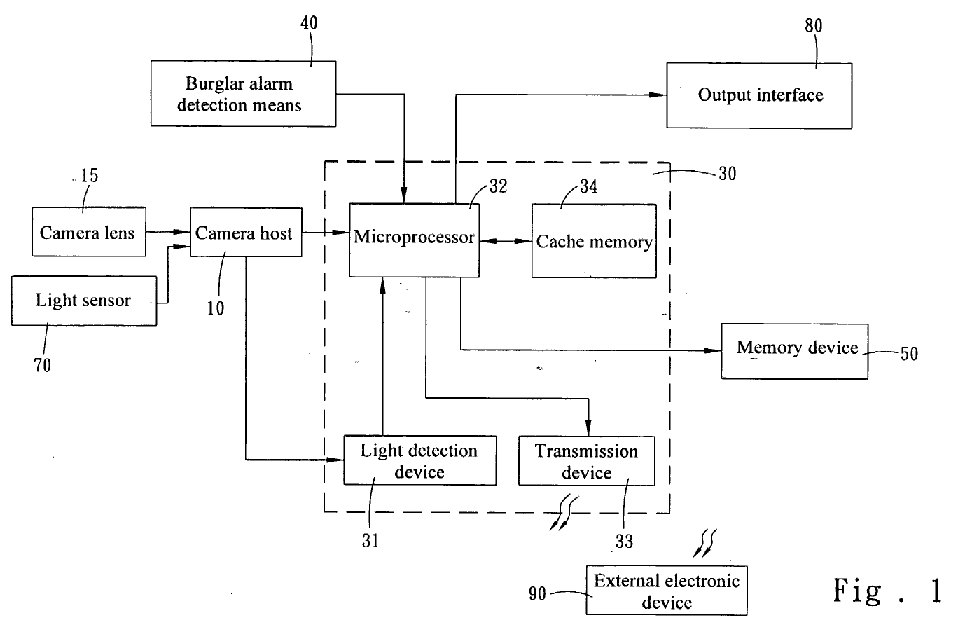

Please refer to FIG. 1, the digital camera according to the invention is capable of transmitting captured image data in a wireless fashion to an, external electronic device 90. It includes a camera host 10, a camera lens 15, a burglar alarm detection means 40 and a control circuit 30. The control circuit 30 includes a microprocessor 32, a cache memory 34 and a transmission device 33. The microprocessor 32 aims to send, receive and process signals of the camera host 10, camera lens 15, cache memory 34, burglar alarm detection means 40 and transmission device 33.

The burglar alarm detection means 40 may be a passive infra-red (PIR) sensor. The camera lens 15 is either a charge-coupled device (CCD) or complementary metal oxide semiconductor (CMOS), and is located on the camera host 10. When the burglar alarm detection means 40 detects movement of human body the microprocessor 32 issues a signal to the camera lens 15 to proceed picturing taking process to get image data. The image data are store temporarily in the cache memory 34, then are transmitted through the transmission device 33 to the external electronic device 90 in a wireless fashion.

In addition the microprocessor 32 may be connected to an output interface 80 to be linked to a computer or TV set to allow users to instantly see the image data which the camera lens 15 is taking. The control circuit 30 also may include a light detection device 31 to detect the external light intensity so that the microprocessor 32 can issue a signal to the camera lens 15 to perform either still picture taking or dynamic video taking process. Hence a most desirable image taking process can be selected according to the external lighting condition. Moreover, the camera host 10 may also include a light sensor 70 to detect the external light intensity, and issue a signal to the light detection device 31 to get the external light intensity condition. It is to be noted that the external light source detected by the light detection device 31 may also be obtained from the camera lens 15.

The microprocessor 32 may also be coupled with a memory device 50. While the camera host 10 is taking pictures and getting image data, if it is temporarily not possible to send the image data to the external electronic device 90 at the remote site, the memory device 50 can store the image data being captured without losing. The transmission device 33 may adopt a remote transmission technique such as 3G transmission system or wireless network system to send the captured image data to the external electronic device 90 such as a PDA, 3G handset, personal computer, or the like.

In short, the invention allows the image data captured by the camera lens 15 to be directly transmitted to the external electronic device 90 to be stored. Hence the digital camera does not need a large capacity of storage for the image data. The cost is lower. Moreover, users can get the images captured by the digital camera at the remote site, and the risk of image data to be sabotaged or tampered can be prevented to enhance the burglar alarm effect to better meet users' requirement.

What is claimed is:

1. A digital camera capable of transmitting image data remotely to capture image data and transmit the image data to an external electronic device, comprising:
a camera host;
a camera lens,
a burglar alarm detection means; and
a control circuit which includes a microprocessor, a cache memory and a transmission device; the microprocessor sending, receiving and processing signals of the camera host, the camera lens, the cache memory, the burglar alarm detection means and the transmission device, the camera lens being located on the camera host; wherein when the burglar alarm detection means detects movement of people and the microprocessor issues a signal to the camera lens to proceed picture taking process to get the image data which are stored temporarily in the cache memory, then are transmitted through the transmission device to the external electronic device in a wireless fashion.

2. The digital camera of claim 1, wherein the transmission device is selectively a 3G transmission system or a wireless network system.

3. The digital camera of claim 1, wherein the burglar alarm detection means is a passive infra-red (PIR) sensor.

4. The digital camera of claim 1, wherein the microprocessor is connected to an output interface to be connected to a computer or a television set.

5. The digital camera of claim 1, wherein the control circuit includes a light detection device to detect external light intensity to allow the microprocessor to issue the signal to the camera lens to selectively perform still image taking process or dynamic video taking process.

6. The digital camera of claim 5, wherein the camera host includes a light sensor to detect the external light intensity to issue another signal to the light detection device of the control circuit.

7. The digital camera of claim 5, wherein the light detection device detects the external light through the camera lens.

8. The digital camera of claim 1, wherein the camera lens is selectively a charge-coupled device (CCD) or a complementary metal oxide semiconductor (CMOS).

9. The digital camera of claim 1, wherein the microprocessor is connected to a memory device to store the image data taken by the camera lens.

10. The digital camera of claim, 1, wherein the external electronic device is selectively a personal digital assistant (PDA), a 3G handset or a personal computer.
